(19) United States
(12) Patent Application Publication
(10) Pub. No.: US 2002/0026632 A1
(43) Pub. Date: Feb. 28, 2002

(54) Universal computer code generator

(75) Inventors: Emmanuel Fuchs, Chatillon (FR); Thierry Lacoste, Versailles (FR)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: AIRSYS ATM SA, Bagneux (FR)

(21) Appl. No.: 09/915,337

(22) Filed: Jul. 27, 2001

(30) Foreign Application Priority Data
Jul. 28, 2000 (FR) 00 09971

(51) Int. Cl. G06F 9/45

(52) U.S. Cl. 717/137

(57) ABSTRACT

This invention relates to a universal computer code generator. The generator comprises at least:

one front end (FE) that creates an intermediate file (6) by a grammatical and syntactical analysis of the specifications file (4), the intermediate file comprising a syntactical tree (20, 30) describing data in the specifications file (4), all data extracted from this file (4) by front end (FE) being associated with a node (21, 22, 23, 24, 25, 26) in the tree;

a Template (3) defining programming rules associated with each node, as a function of the code to be generated (7);

a back end (BE) generating the output code (7) by reading the intermediate file (6) and the syntactical tree.

The invention is applicable particularly for automatic code generation, for example for translation of computer languages.

This invention relates to a universal computer code generator. It is applicable particularly for automatic code generation, for example for translations of computer languages.

In particular, one purpose of an automatic code generator is to save time and therefore reduce costs of the development of systems using computer programs. The generated code may require a very large number of lines, for example several tens of thousands of lines. This requires a great deal of time and one or more programmers. Automatic code generation has other advantages over human programming. Firstly, the generated code is consistent. Thus when an error is detected, the correction can be applied uniformly in all files containing this error.

Firstly a code generator requires a specifications file. This file contains data from the user. For example, these data are presented in the form of a high level computer language, for example such as IDL 2, IDL 3 or ADA. Furthermore, the generator requires a set of rules by which the user defines the use of data existing in the specification file in order to define the appropriate code. One disadvantage is that these rules have to be defined as a function of each language. In other words, a new set of rules has to be defined for each new language. However, there is a very large number of languages. Therefore, a different code generator needs to be produced for each existing computer language, and this is expensive and difficult.

Finally, a large number of systems use common interfaces programmed in the same language. The heterogeneity of the languages used thus makes it necessary to translate these languages into languages adapted to interfaces, in other words to create a code adapted to these interfaces.

One purpose of the invention is to enable the production of an automatic code generator independent of the languages used. One purpose of the invention is a computer code generator starting from a specification file that comprises at least:

one front end FE that creates an intermediate file by a grammatical and syntactical analysis of the specifications file, the intermediate file comprising a syntactical tree describing data in the specifications file, all data extracted from this file by front end FE being associated with a node in the tree;

a Template defining programming rules associated with each node, as a function of the code to be generated;

a back end BE generating the code by reading the intermediate file and the syntactical tree.

The front end FE reads a file describing the grammar of the specifications file language. It breaks down the specifications file into software elements forming nodes in the syntactical tree based on a functional tree structure conform with the specifications file, the software elements being data extracted from this file.

The Template comprises programming rules for the output language associated with each software element of a node, a rule and the manner in which this rule is applied being associated with each node. For example, the software elements associated with nodes may be interfaces, variables, constants, operations and logical or mathematical functions.

In particular, the main advantages of the invention are that it enables savings in the production of a computer code generator and that it enables excellent flexibility in using such a generator.

Other characteristics and advantages of the invention will become clear after reading the following description with respect to the attached drawings that represent:

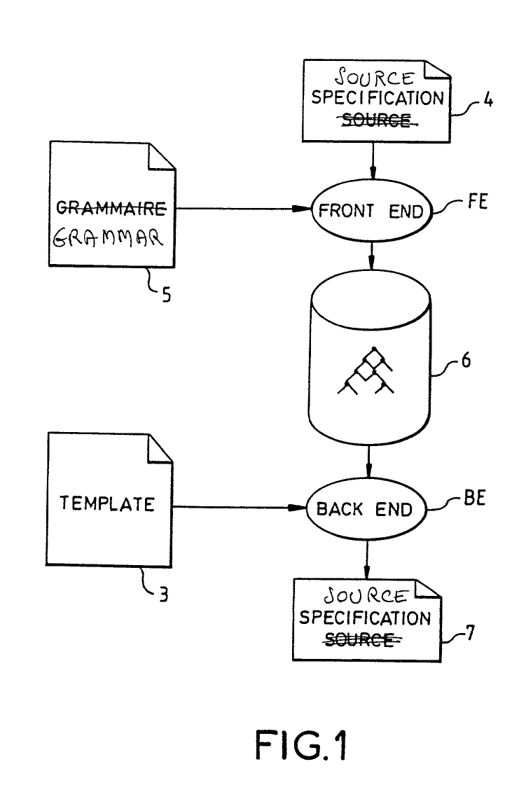

FIG. 1, a view of the software architecture of a code generator according to the invention;

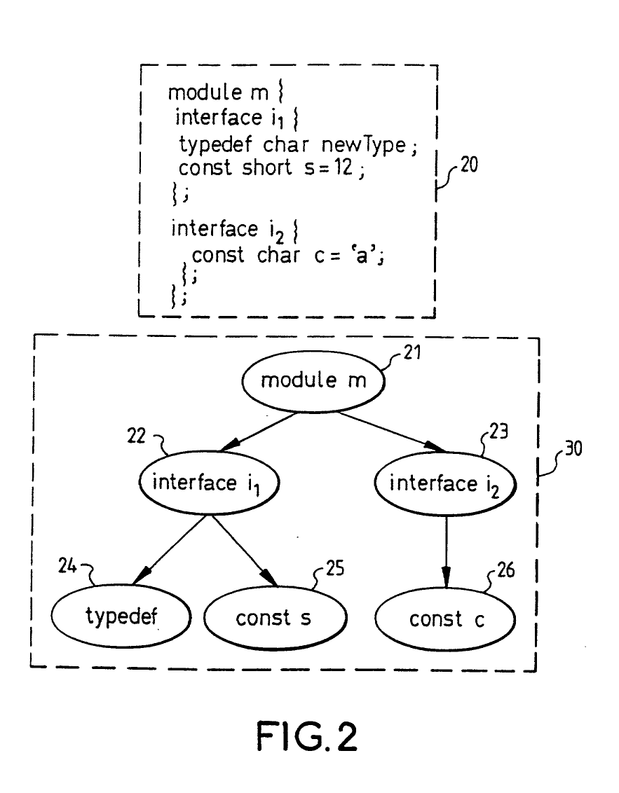

FIG. 2, an example of a coded representation and an example of a schematic representation of a syntactical tree used by an encoder according to the invention.

FIG. 1 illustrates an example embodiment of a code generator according to the invention. It comprises several parts, and particularly a front end FE, a back end BE and a template file 3 also called the “Template” in the rest of this document.

The front end FE communicates with the specifications file 4 for a start language, for example a language to be translated, into another language. This front end FE also communicates with a file 5 describing the grammar of the specifications file language. Therefore, the front end FE processes two series of input data, firstly the data supplied by the specifications file 4 describing in particular the language syntax, and also data supplied in the grammar file 5. The grammatical analysis is done conventionally by the FE so that the FE can extract the highest level data contained in the specifications file 4.

The front end FE generates an intermediate file 6 that comprises a syntactical tree representing the analyzed file 4. For example, this tree contains all data extracted from this specifications file 4, but does not keep any other specific features of the language used in this file 4. For example, the intermediate file 6 is written in ASCII code.

The back end BE outputs the output specifications file 7. For example, this file contains the translation of the input language 4 into a new computer language. The output language may be any type of language, for example the C language or the ADA language. The BE requires two series of input data, data supplied by the intermediate file 6 created by the front end FE, in other words the syntactical tree contained in it, and data supplied by the Template 3. The Template describes how the data contained in this intermediate file 6 are used, and how they are processed to generate the right code. Advantageously, the BE is entirely generic and is never changed or modified when there is a new specifications file 4, and therefore a new language, at the input to the front end FE. The Template 3 must be created by users. In particular, this function depends on the code or language to be generated. In particular, it is used to access data from the input specifications 4, to manipulate and transform them, and thus enables the BE to generate the expected code. Consequently, it comprises all functions necessary to extract data from the intermediate file 6.

FIG. 2 presents an example of an organization of an intermediate file 6. The front end FE breaks down the input specifications 4 into basic software elements 21, 22, 23, 24, 25, 26 forming nodes connected to each other according to a functional tree structure complying with specifications 4. The software elements are data extracted from the specifications file 4. For example, the syntactical tree illustrated in FIG. 2 contains a small number of software units, particularly to facilitate the description of the intermediate file 6. This syntactical tree is represented as an example of a coded form 20, and as an example of the schematic form 30. In particular, the syntactical tree in FIG. 2 is related to a subprogram, in other words a structure or module m contained in the specifications file 4. After the grammatical and syntactical analysis of this file 4, the front end FE detects a module m. It then creates a node 21 corresponding to this module, for example this node being integrated into a more general tree structure. The analysis carried out by the FE then enables it to detect that the module m processes two interfaces, an interface i₁ and an interface i₂. Consequently, it creates a node 22 corresponding to the interface i₁ connected on the output side to node 21 of module m, and it creates a node 23 corresponding to interface i₂ connected on the output side to node 21 of module m. Going down one level in the tree structure, a first node 24 and a second node 25 are connected to node 22 in interface i₁, and a third node 26 is connected to node 23 in interface i₂. The first and second nodes 24, 25 correspond to a variable and a constant respectively for the interface i₁. The third node corresponds to a constant c used for the interface i₂. In particular, the nodes associated with variables and the constants may be placed at the end of the branch. For example, for an air traffic control application, these variables are data related to aircraft or runways.

In particular, a template file programmer 3 must manipulate data contained in the intermediate file 6. However, these data may be stored such that they are not easily accessible. Consequently, the syntactical tree may be presented in diagrammatic form 30 to the programmer. This is actually a presentation of original specifications data 4 organized according to a logical tree. Thus, for each structure in the specifications language used, the Template 3 can access data applicable to this structure, for example module m, interfaces i₁, i₂, constants s and a, and can browse through this structure in the syntactical tree.

In the Template 3, a rule is associated with each node in the syntactical tree, together with the manner in which this rule is applied. Furthermore, the syntactical tree is a means of recognizing the nature of objects or software elements associated with nodes. For example, possible natures are interfaces, variables, constants and logical or mathematical operations and functions. Rules are adapted to each type or each nature of software element. In particular, in the case of an interface, the physical address of the interface must be indicated together with an example of a communication protocol known elsewhere. Variables and constants must be specified. For example, variables may be representative of speeds, position or any other type of physical magnitudes. For example, for node 21 associated with module m, the instructions file 3 contains programming rules for interfaces i₁ and i₂. Similarly for each node 22, 23 associated with these interfaces, rules are given for programming of constants or variables corresponding to lower level nodes 24, 25, 26. Obviously, the programming rules associated with each node depend on the output language 7. Therefore the instruction file includes programming rules for the output language, associated with each software element of a node.

The instructions file 3 controls the BE. In particular it extracts data 21, 22, 23, 24, 25, 26 from the intermediate file 6 and controls code generation done by the BE that uses these data. In particular, it is possible to create as many instructions files 3 as are necessary to process a single type of input specifications file. This input file can then be the source of several different code generations, in other words actually several different languages. In particular, an instructions file 3 is associated with each output language.

Several types of programming languages can be used to create the instruction file 3. A particular language may be adapted to writing this file 3. This language will subsequently be called TDL for <<Templates Description Language>>. The TDL language may be a complete programming language that deals with conventional software elements, for example such as elements allowed in the C language, in other words particularly structure controls (if, for, do, while . . . ), variables, functions and classes. Thus for example, its syntax may resemble the syntax of the C++ language that makes it easy for a programmer to create an instructions file 3. The TDL language makes it easy to manipulate all types of variables or objects. It may be powerful enough to manipulate data sequences or instruction sequences. The generated code 7 is nothing more than a concatenation of a large number of instruction sequences that can thus be easily produced. For example, the TDL language comprises all instructions necessary to browse through the syntactical tree 20, 30. In particular, TDL comprises an instruction class corresponding to each type of node in the tree, in particular to obtain all information contained in the node. For example, TDL can be used to mix constant code and variable code. In particular, this means that some parts of the instructions file 3 may be reproduced directly in the output file 7 without interpretation, while other parts are interpreted by the BE. It is thus easy to generate large sections of constant code by placing these sections entirely in the instructions file 3.

A code generator according to the invention is genuinely generic since the back end BE remains the same regardless of the language of the input specifications 4. In particular, the BE may be hard coded. Therefore, the advantages provided by the invention are particularly that they enable savings during production, and increased flexibility. Thus, the invention can translate any computer language defined by the input specifications file 4 into any other language supplied by the output file 7. As a variant embodiment, it would be possible to associate the front end FE with a Template, so that this end would not need to be modified as a function of the input language.

1. Computer code generator starting from a specifications file, characterized in that it comprises at least:
one front end (FE) that creates an intermediate file (6) by a grammatical and syntactical analysis of the specifications file (4), the intermediate file comprising a syntactical tree (20, 30) describing data in the specifications file (4), all data extracted from this file (4) by front end (FE) being associated with a node (21, 22, 23, 24, 25, 26) in the tree;
a Template (3) defining programming rules associated with each node, as a function of the code to be generated (7);
a back end (BE) generating the output code (7) by reading the intermediate file (6) and the syntactical tree.

2. Generator according to claim 1, characterized in that the front end (FE) reads a file (5) describing the grammar of the specifications file (4) language.

3. Generator according to either of the previous claims, characterized in that the front end (FE) breaks down the specifications file (4) into software elements (21, 22, 23, 24, 25, 26) forming the nodes of the syntactical tree, according to a functional tree structure conform with the specifications file (4), the software elements being data extracted from this file (4).

4. Generator according to any one of the previous claims, characterized in that the Template (3) comprises output code programming rules (7) associated with each software element of a node, a rule and the manner in which this rule is applied being associated with each node.

5. Generator according to any one of the previous claims, characterized in that the software elements associated with the nodes are interfaces, variables, constants, operations and logical or mathematical functions.

6. Generator according to any one of the previous claims, characterized in that the output code (7) is a computer language.
